(19) United States
(12) Patent Application Publication
(10) Pub. No.: US 2019/0381601 A1
(43) Pub. Date: Dec. 19, 2019

(54) LASER WELDING METHOD AND WELDED STRUCTURE

(71) Applicant: TOYOTA JIDOSHA KABUSHIKI KAISHA, Toyota-shi (JP)

(72) Inventors: Ryuta MATSUO, Aichi-gun (JP); Shuhei OGURA, Nagakute-shi (JP); Hiroki SUGINO, Toyota-shi (JP)

(73) Assignee: TOYOTA JIDOSHA KABUSHIKI KAISHA, Toyota-Shi (JP)

(21) Appl. No.: 16/437,840

(22) Filed: Jun. 11, 2019

(30) Foreign Application Priority Data
Jun. 19, 2018 (JP) 2018-116038

(51) Int. Cl. B23K 26/22; B23K 26/06; B23K 26/064; B23K 26/073; B23K 26/32

(52) U.S. Cl. CPC B23K 26/22; B23K 26/0608; B23K 2103/04; B23K 26/073; B23K 26/32; B23K 26/064

(57) ABSTRACT

A laser welding method and a welded structure are provided to improve joining strength by increasing the throat depth and to prevent cracks due to stress concentration by increasing an angle at the back of the throat. The laser welding method for lap welding of multiple layered steel plates by irradiation with a laser beam includes: a step of forming a molten pool penetrating the first steel plate in a layer direction and reaching the second steel plate by irradiating the first steel plate with a first laser beam LB1; and a step of melting an outer peripheral edge of the molten pool by irradiating an outer periphery of the molten pool on the first steel plate with a second laser beam LB2 having a spot diameter D2 larger than a spot diameter D1 of the first laser beam LB1.

### CROSS-REFERENCE TO RELATED APPLICATIONS

The present application claims priority under 35 U.S.C. § 119(a) to Japanese Patent Application No. 2018-116038, filed on Jun. 19, 2018. The contents of this application are incorporated herein by reference in its entirety.

### TECHNICAL FIELD

The present invention relates to a laser welding method for lap welding of a plurality of steel plates layered on each other by being irradiated with a laser beam, and also relates to a welded structure formed by the laser welding method.

### BACKGROUND ART

Conventionally, a laser welding method is known, in which a plurality of layered steel plates is irradiated with a laser beam so as to form a molten pool in the plurality of layered steel plates, and in which the plurality of steel plates are joined to each other by a welding part as a congealed molten pool.

However, in the above method, the gap among the plurality of layered steel plates is filled with the molten metal. Thus, when the gap is large, the amount of molten metal is increased so as to fill the gap, which causes a depression on the surface of the molten pool. In the result, the surface of the welding part, which is formed by the congealed molten pool, also has a depression. In the case where the surface of the welding part is depressed, it is difficult to ensure the throat depth of the welding part (i.e. the shortest distance between the outer peripheral edge of the welding part on the rear surface of the upper steel plate and the surface of the welding part), which may result in reduction in the joining strength.

In consideration of the above, Patent Document 1 discloses, for example, a laser welding method in which: a plurality of layered plates is irradiated with a laser beam such that a molten pool is formed in the layered plates; and an outer edge of the molten pool is irradiated with the laser beam such that the outer edge is molten and that the plurality of layered plates is welded.

In the method disclosed in Patent Document 1, since the outer edge of the molten pool is molten by irradiation with the laser beam, the molten outer edge flows toward the central part of the molten pool, so that the surface of the welding part becomes flat. Thus, the throat depth of the welding part is increased, and it is expected that the joining strength is prevented from decreasing even when the gap is large.

### PRIOR ART DOCUMENT

### Patent Document

Patent Document 1: JP 2012-228717 A

### SUMMARY OF THE INVENTION

### Problem to be Solved by the Invention

The throat depth is defined by the shortest distance between the outer peripheral edge of the welding part on the rear surface of the steel plate and the surface of the welding part. Thus, in order to obtain a sufficient throat depth, it is preferable to approach the above object not only from the surface side of the steel plate but also from the rear surface side of the steel plate. In this context, Patent Document 1 addresses the problem at the surface side of the steel plate by reducing the depression on the surface of the welding part, however, it does not address any problem at the rear surface side of the steel plate. Thus, the throat depth is not yet sufficiently ensured, and in this respect, there is a room for improvement.

Furthermore, the outer peripheral edge of the welding part on the rear surface of the steel plate is likely to be an origin of a crack due to stress concentration. In order to reduce the stress concentration, it is effective to increase an angle at the back of the throat (i.e. an angle made by the rear surface of the upper steel plate and the outer peripheral surface of the welding part). However, in Patent Document 1, the welding part bridges the gap among the plurality of steel plates in the direction perpendicular to a plane orthogonally intersecting with the layer direction. Therefore, the angle at the back of the throat is not sufficiently ensured, and in this respect also, there is a room for improvement.

The present invention was made in consideration of the above circumstances, an object of which is to provide a laser welding method for lap welding of a plurality of steel plates layered on each other and to provide a welded structure, in which a throat depth is increased to improve the joining strength, and in which an angle at the back of the throat is increased to prevent generation of a crack due to stress concentration.

### Means for Solving the Problem

In order to achieve the above object, in a laser welding method and a welded structure of the present invention, the steel plates are bridged by a welding part having an outer peripheral surface largely inclined relative to a plane orthogonally intersecting with the layer direction.

Specifically, the present invention is directed to a laser welding method for lap welding of a plurality of steel plates layered on each other by irradiation with a laser beam.

In the laser welding method, the plurality of steel plates is constituted from first to n-th steel plates (n is an integer equal to or greater than 2) in this order from a surface to be irradiated with the laser beam. The method includes: a step of forming a molten pool that penetrates between the first steel plate and a (n−1)-th steel plate in the layer direction and that reaches the n-th steel plate by irradiating the first steel plate with a first laser beam; and a step of melting an outer peripheral edge of the molten pool by irradiating an outer periphery of the molten pool on the first steel plate with a second laser beam having a spot diameter larger than a spot diameter of the first laser beam.

In the above-described configuration, in the first step, when the molten pool that reaches the n-th steel plate is formed by irradiating the first steel plate with the first laser beam, the gap among the steel plates is filled with the molten metal. Therefore, if the gap is large, the surface of the molten pool is largely depressed toward the second steel plate, and furthermore, the molten metal drops perpendicular to the rear surface (i.e. the plane orthogonally intersecting the layer direction) of the first steel plate.

However, in the next step, the outer periphery of the molten pool on the first steel plate is irradiated with the second laser beam having a relatively large spot diameter and a relatively low energy density so that a wide and shallow heat-transfer melting is performed. Thus, the first steel plate is gently molten so that the molten pool expands. In this way, it is possible to flow the molten metal toward the central part of the molten pool and to fill the depression on the surface of the molten pool. Also, it is possible to cause the molten metal to fall obliquely relative to the rear surface of the first steel plate.

Thus, in the welding part that is made from the molten pool after congelation, the surface of the welding part is hardly depressed and thus is substantially flat. In addition, the outer peripheral surface of the welding part can be largely inclined relative to the rear surface of the first steel plate. In this way, it is possible to increase the throat depth that is defined by the shortest distance between the outer peripheral edge of the welding part on the rear surface of the first steel plate and the surface of the welding part, which leads to improvement of the joining strength. Furthermore, since the first steel plate and the second steel plate are bridged by the welding part having the outer peripheral surface that is largely inclined relative to the rear surface of the first steel plate, the angle at the back of the throat can be increased. Therefore, it is possible to reduce the stress concentration that is generated at the outer peripheral edge of the welding part on the rear surface of the first steel plate.

Also in the above-described laser welding method, it is preferable that scanning and irradiation are circularly performed with the first laser beam such that the molten pool is formed.

The fatigue strength of the welding part is defined by the nugget diameter (i.e. the diameter of the welding part on the surface of the n-th steel plate) and the largeness of the throat depth. With this configuration, the scanning and the irradiation with the first laser beam can be performed circularly (i.e. in a manner of rotating, using a so-called laser screw welding (LSW) method). Thus, it is possible to easily obtain a relatively large nugget diameter, which contributes to improvement of the fatigue strength of the welding part.

Furthermore, in the above-described laser welding method, it is preferable that a thickness of the first steel plate is smaller than respective thicknesses of the second to n-th steel plates.

When the gap is filled with the molten metal, if the gap among the steel plates is relatively large and the thickness of the first steel plate is relatively thin, the throat depth remarkably decreases. In this respect, in the present invention, the wide and shallow heat-transfer melting is performed along the outer periphery of the molten pool on the first steel plate so as to increase the throat depth and the angle at the back of the throat. Thus, even when the thickness of the first steel plate is relatively thin, the present invention is suitably applied.

Also, the present invention is directed to a welded structure made by lap welding of a plurality of steel plates layered on each other by irradiation with a laser beam.

In the above welded structure, the plurality of steel plates is constituted from first to n-th steel plates (n is an integer equal to or greater than 2) in this order from a surface to be irradiated with the laser beam. The welded structure includes a welding part made from a molten pool after congelation. The welding part penetrates between the first steel plate and a (n−1)-th steel plate in a layer direction and reaches the n-th steel plate. An inclination angle of the welding part at a position corresponding to a gap between the first steel plate and a second steel plate relative to a plane orthogonally intersecting with the layer direction is smaller than an inclination angle of the welding part at a position within the second steel plate relative to the plane orthogonally intersecting with the layer direction.

When the welding part perpendicularly bridges from the first steel plate to the second steel plate, the inclination angle of the welding part at a position corresponding to the gap between the first steel plate and the second steel plate relative to the plane orthogonally intersecting with the layer direction is larger than the inclination angle of the welding part at a position within the second steel plate relative to the plane orthogonally intersecting with the layer direction. In contrast, in the present invention, the inclination angle of the welding part at a position corresponding to the gap between the first steel plate and the second steel plate relative to the plane orthogonally intersecting with the layer direction is smaller than the inclination angle of the welding part at a position within the second steel plate relative to the plane orthogonally intersecting with the layer direction. That is, since the welding part is formed such that the angle at the back of the throat is relatively large, it is possible to increase the throat depth and to reduce generation of cracks due to stress concentration.

Furthermore, in the above-described welded structure, it is preferable that the thickness of the first steel plate is smaller than the respective thicknesses of the second to n-th steel plates.

In the present invention, the welding part is formed such that the angle at the back of the throat is relatively large. Thus, the present invention is suitably applied to the case in which the thickness of the first steel plate is relatively small.

### Advantageous Effect of the Invention

As described above, with the laser welding method and the welded structure of the present invention, a throat depth is increased to improve the joining strength and furthermore an angle at the back of the throat is increased to prevent generation of a crack due to stress concentration.

### BRIEF DESCRIPTION OF THE DRAWINGS

FIG. 1 is a cross-sectional view schematically illustrating a welded structure according to an embodiment of the present invention. [FIGS. 2(a) and 2(b)] FIGS. 2(a) and 2(b) are configuration diagrams schematically illustrating a laser welding apparatus to perform a laser welding method according to the embodiment of the present invention.

FIG. 3 is a diagram schematically illustrating parameters to define the fatigue strength of the welded structure.

FIG. 4 is a perspective view schematically explaining the laser welding method.

FIGS. 5(a), 5(b) and 5(c) are diagrams schematically explaining the laser welding method.

FIGS. 6(a) and 6(b) are diagrams schematically explaining respective molten states in the laser welding method. FIG. 6(a) shows a keyhole melting. FIG. 6(b) shows a heat-transfer melting.

FIG. 7 is a perspective view schematically illustrating a method for setting steel plates in an experimental example.

FIGS. 8(a), 8(b) and 8(c) are diagrams explaining a conventional welded structure. FIG. 8(a) is a stress analysis diagram of the conventional welded structure. FIG. 8(b) is a diagram schematically illustrating the conventional welded structure after being submitted to a fatigue test. FIG. 8(c) is a graph indicating a relationship between the angle at the back of the throat and the number of cycles to failure.

FIGS. 9(a) and 9(b) are diagrams explaining a conventional laser welding method. FIG. 9(a) is a perspective view schematically illustrating the conventional laser welding method. FIG. 9(b) is a cross-sectional view schematically illustrating the welded structure formed by the conventional laser welding method.

FIGS. 10(a) and 10(b) are cross-sectional views schematically illustrating respective cases in which irradiation is performed with a laser beam having a relatively high energy density. FIG. 10 (a) shows a case in which the gap is relatively small. FIG. 10(b) shows a case in which the gap is relatively large.

FIGS. 11(a) and 11(b) are diagrams schematically explaining the conventional laser welding method.

### DESCRIPTION OF EMBODIMENT

Hereinafter, an embodiment of the present invention will be described with reference to the drawings.

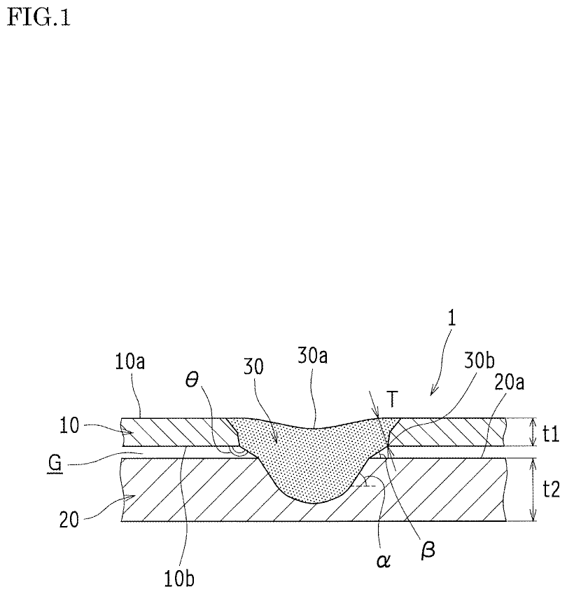

FIG. 1 is a cross-sectional view schematically illustrating a welded structure 1 according to this embodiment. As shown in FIG. 1, the welded structure 1 is formed by lap welding of a first steel plate 10 and a second steel plate 20 that are layered on each other and irradiated with a laser beam. Hereinafter, an upper surface of the first steel plate 10 in FIG. 1 is referred to as a “surface 10a” and a lower surface of the first steel plate 10 in FIG. 1 is referred to as a “rear surface 10b”. Also, an upper surface of the second steel plate 20 in FIG. 1 is referred to as a “surface 20a”.

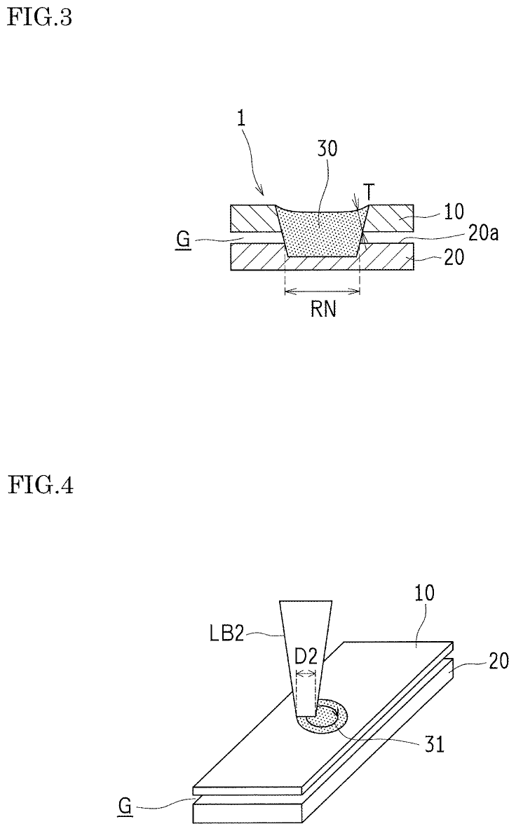

The first steel plate 10 and the second steel plate 20 are galvanized steel plates. The thickness t1 of the first steel plate 10 is thinner than the thickness t2 of the second steel plate 20. In this welded structure 1, the first steel plate 10 and the second steel plate 20 face each other in a layer direction (i.e. the vertical direction in FIG. 1) with a relatively large gap G being interposed therebetween while they are joined to each other in the layer direction by a welding part 30 formed such that the gap G is filled with the welding part 30. The welding part 30 is a congealed molten pool 31 (see FIG. 4). The molten pool 31 is formed by being irradiated with the laser beam so as to penetrate the first steel plate 10 in the layer direction and to reach the second steel plate 20.

Here, the following (1) to (3) should be noted.

(1) Generally, when the lap welding is performed by irradiation with the laser beam, the gap G is filled with the welding part 30. Thus, when the gap G is relatively large, the amount of molten metal is increased so as to fill the gap G, which causes a depression on the surface of the molten pool 31. In the result, a surface 30a of the welding part 30, which is formed by the congealed molten pool 31, is likely to have a depression. However, in the welded structure 1, the depression on the surface 30a of the welding part 30 is small, that is, the surface 30a is substantially flat.

(2) Generally, the welding part 30 bridges from the first steel plate 10 to the second steel plate 20 in the direction perpendicular to the rear surface 10b (plane orthogonally intersecting with the layer direction) of the first steel plate 10. However, in the welded structure 1, the welding part 30 that bridges from the first steel plate 10 to the second steel plate 20 has an outer peripheral surface largely inclined relative to the rear surface 10b of the first steel plate 10. In other words, an “angle θ at the back of the throat” is relatively large, which is made by the rear surface 10b of the first steel plate 10 and the outer peripheral surface of the welding part 30.

(3) When the gap G is relatively large and furthermore the first steel plate 10 is relatively thin (i.e. thickness t1<thickness t2), a throat depth T (i.e. the shortest distance between the outer peripheral edge 30b of the welding part 30 on the rear surface 10b of the first steel plate 10 and the surface 30a of the welding part 30) is likely to remarkably decrease. However, in the welded structure 1, a relatively large throat depth T is maintained.

Hereinafter, the laser welding method of this embodiment, by which the above-described welded structure 1 can be produced, will be described in detail.

### —Laser Welding Apparatus—

FIGS. 2(a) and 2(b) are configuration diagrams schematically illustrating a laser welding apparatus 50 to perform the laser welding method of this embodiment. The laser welding apparatus 50 is configured as a remote laser that performs laser welding by irradiating a workpiece W with a laser beam LB from a position separated from the workpiece W. As shown in FIG. 2(a), the laser welding apparatus 50 includes: a laser oscillator 51 that outputs the laser beam LB; a robot 52; and a 3D scanner 60 that scans the laser beam LB supplied, via a fiber cable 54, from the laser oscillator 51 so as to irradiate the workpiece W. The robot 52 is an articulated robot having a plurality of joints driven by a plurality of servomotors (not shown), and is configured to move the 3D scanner 60 that is attached to a tip part thereof according to instructions from a control device (not shown).

As shown in FIG. 2(b), the 3D scanner 60 includes: a sensor 61; a collecting lens 62; a stationary mirror 63; a movable mirror 64; and a converging lens 65. The laser beam LB supplied from the laser oscillator 51 to the 3D scanner 60 is emitted from the sensor 61 to the collecting lens 62 and collected by the collecting lens 62. After that, the collected laser beam LB is reflected by the stationary mirror 63 toward the movable mirror 64 that changes the direction of the laser beam LB. Then, the laser beam LB passes through the converging lens 65 so that the laser beam with a predetermined spot diameter is emitted toward the workpiece W. By the above-described configuration of the laser welding apparatus 50 of this embodiment, the movable mirror 64 is driven according to the instructions from the control device (not shown), thus the 3D scanner 60 can irradiate, with the laser beam LB, a predetermined area within a radius of 200 mm in a state in which the 3D scanner 60 is separated from the workpiece W by 500 mm.

The collecting lens 62 is movable in the vertical direction by an actuator (not shown). Thus, the focal length is adjusted in the vertical direction by moving the collecting lens 62 in the vertical direction. In this way, in the laser welding apparatus 50 of this embodiment, when the upper surface of the workpiece W is set to a reference (zero; 0), it is possible to change the spot diameter by shifting the focus F in the + direction or in the − direction.

### —Laser Welding Method—

Here, the laser welding method of the present embodiment using the laser welding apparatus 50 will be described. However, before this description, a conventional laser welding method in the case in which the gap G is relatively large is described, which will facilitate comprehension of the present invention.

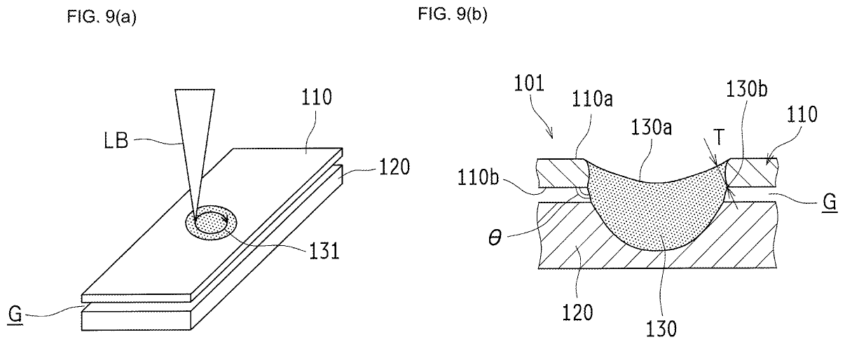

FIG. 9(a) is a perspective view schematically illustrating the conventional laser welding method. FIG. 9(b) is a cross-sectional view schematically illustrating a welded structure 101 formed by the conventional laser welding method. As shown in FIG. 9(a), in the conventional laser welding method, a first steel plate 110 and a second steel plate 120, which are layered on each other so as to have a relatively large gap G, are irradiated with the laser beam LB that has a relatively small spot diameter and has a relatively high energy density. In this way, a molten pool 131 is formed so as to penetrate the first steel plate 110 in the layer direction and to reach the second steel plate 120.

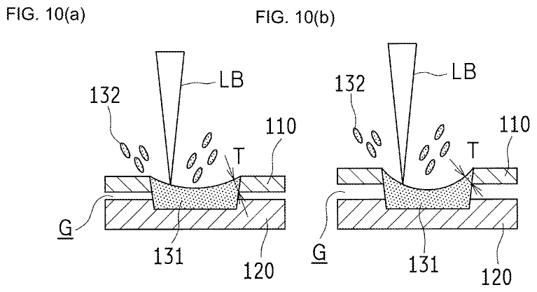

FIGS. 10(a) and 10(b) are cross-sectional views schematically illustrating respective cases in which the irradiation is performed with the laser beam LB having a relatively high energy density. FIG. 10 (a) shows a case in which the gap G is relatively small. FIG. 10(b) shows a case in which the gap G is relatively large. When the first steel plate 110 is irradiated with the laser beam LB having a relatively high energy density, molten metal particles 132 are scattered (spattering) while the molten metal is used to fill the gap G, accordingly, the surface of the molten pool 131 is depressed, as shown in FIG. 10(a). However, in the case in which the gap G is relatively small, the amount of molten metal with which the gap G is to be filled is also small. Thus, it is possible to ensure the throat depth having a large thickness to a certain extent when the molten pool 131 congeals and becomes a welding part 130.

On the other hand, in the case in which the gap G is relatively large, when the first steel plate 110 is irradiated with the laser beam LB having a relatively high energy density, the molten metal particles 132 are scattered while the large amount of molten metal is used to fill the gap G, accordingly, the surface of the molten pool 131 is largely depressed, as shown in FIG. 10(b). Consequently, the throat depth T is thin when the molten pool 131 congeals and becomes the welding part 130.

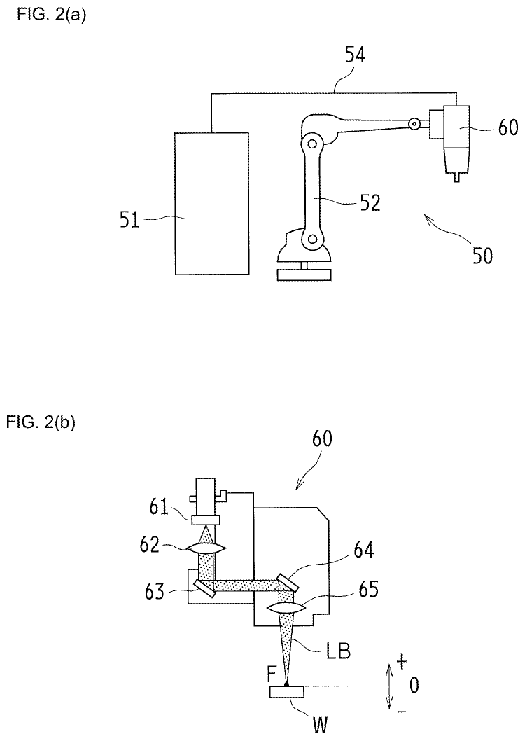

The joining strength of the welded structure 1 subjected to the lap welding with the laser beam LB is mainly evaluated by the tensile shear test. However, actually, the load is repeatedly applied to the welded structure 1. Therefore, it is important to evaluate the fatigue strength. It is generally known that the fatigue strength of the welded structure 1 is defined by largeness of the nugget diameter RN (diameter of the welding part 30 on the surface 20a of the second steel plate 20) and largeness of the throat depth T, as shown in FIG. 3.

Accordingly, in the welded structure 101 formed by the conventional laser welding method in which the first steel plate 110 and the second steel plate 120, which are layered on each other so as to have a relatively large gap G, are irradiated with the laser beam LB having a relatively high energy density, the surface of the molten pool 131 is largely depressed, which means that a surface 130a of the welding part 130 formed by congelation of the molten pool 131 is largely depressed, as shown in FIG. 10(b). Thus, it is difficult to ensure a relatively large throat depth T, which results in reduction in the fatigue strength.

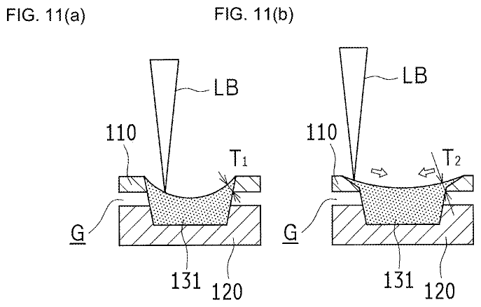

Then, it may be considered that, after the molten pool 131 is formed by irradiation with the laser beam LB having a relatively high energy density as shown in FIG. 11(a), the outer edge of the molten pool 131 is irradiated with the laser beam LB having a relatively high energy density as shown in FIG. 11(b) such that the molten outer edge flows toward the central part of the molten pool 131 as indicated by the outlined arrows in FIG. 11(b). Thus, the throat depth T2, which is larger than the throat depth T1, can be obtained.

However, when the first steel plate 110 is relatively thin, that is, when the volume of the base material that becomes the molten metal is small, the increasing rate of the throat depth T is small even when the outer edge of the molten pool 131 is irradiated with the laser beam LB having a relatively high energy density such that the molten outer edge flows toward the central part of the molten pool 131.

The throat depth T is defined by the shortest distance between an outer peripheral edge 130b of the welding part 130 on a rear surface 110b of the first steel plate 110 and the surface 130a of the welding part 130. Thus, in order to obtain a sufficient throat depth, it is preferable to approach the above object not only from a surface 110a side of the first steel plate 110 but also from the rear surface 110b side of the first steel plate 110. The conventional laser welding method shown in FIG. 11(b) addresses the problem only at the surface 110a side of the first steel plate 110 by reducing the depression on the surface 130a of the welding part 130, however, it does not address any problem at the rear surface 110b side of the first steel plate 110. Thus, the throat depth T is not yet sufficiently ensured, and in this respect, there is a room for improvement.

Furthermore, the outer peripheral edge of the welding part 130 on the rear surface 110b of the first steel plate 110 is likely to be an origin of a crack due to stress concentration. In order to reduce the stress concentration, it is effective to increase the angle θ at the back of the throat. However, in the conventional welded structure 101, the welding part 130 bridges from the first steel plate 110 to the second steel plate 120 in the direction substantially perpendicular to the rear surface 110b of the first steel plate 110. Therefore, the angle θ at the back of the throat is not sufficiently ensured, and in this respect also, there is a room for improvement.

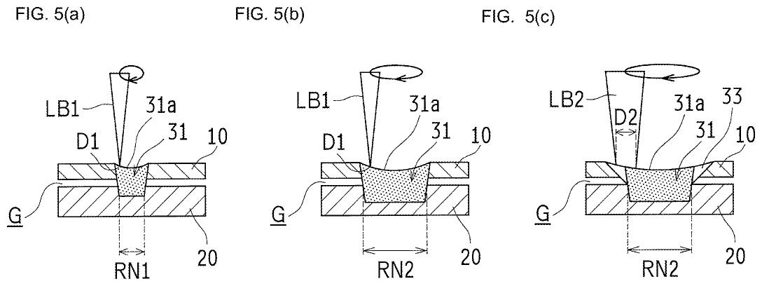

In this embodiment, the welding part 30 that bridges from the first steel plate 10 to the second steel plate 20 has an outer peripheral surface largely inclined relative to the rear surface 10b (i.e. the plane orthogonally intersecting with the layer direction) of the first steel plate 10. Specifically, the laser welding method of this embodiment includes: steps in which the first steel plate 10 is irradiated with a first laser beam LB1 (see FIG. 5) so as to form the molten pool 31 that penetrates the first steel plate 10 in the layer direction and that reaches the second steel plate 20 (i.e. the first step and the second step); and a step in which an outer periphery of the molten pool 31 on the first steel plate 10 is irradiated with a second laser beam LB2 that is set to have a spot diameter D2 larger than a spot diameter D1 of the first laser beam LB1, as shown in FIG. 4, so as to melt the outer peripheral edge of the molten pool 31 (the third step). Hereinafter, the above laser welding method is described in detail.

### —First Step—

FIGS. 5(a), 5(b) and 5(c) are diagrams schematically explaining the laser welding method. In the first step of the laser welding method of this embodiment, the first steel plate 10 and the second steel plate 20, which are layered on each other so as to have a relatively large gap G, are circularly scanned and irradiated with the first laser beam LB1 that has a relatively small spot diameter D1 and has a relatively high energy density, by a method so-called “Laser Screw Welding” (LSW) as shown in FIG. 5(a).

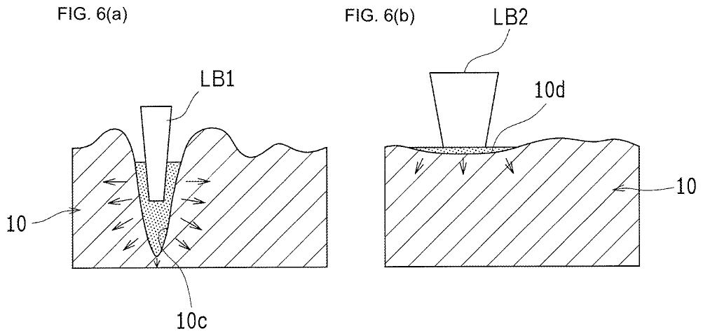

FIGS. 6(a) and 6(b) are diagrams schematically explaining respective molten states in the laser welding method. FIG. 6(a) shows a keyhole melting. FIG. 6(b) shows a heat-transfer melting. In the first step, since the irradiation is performed with the first laser beam LB1 having a relatively high energy density, the keyhole melting is performed as shown in FIG. 6(a). More specifically, due to the irradiation with the first laser beam LB1 having the relatively high energy density, the first steel plate 10 sublimates and the convection of metal vapor is generated, which leads to the state in which a deep keyhole 10c is formed in the first steel plate 10 as shown in FIG. 6(a). Due to such a deep keyhole 10c, the heat absorption area is increased, which causes rapid and violent melting of the first steel plate 10 as indicated by the arrows in FIG. 6(a). As a result, the amount of molten metal that is scattered (spatter amount) is increased.

In the molten pool 31 that is formed so as to penetrate the first steel plate 10 and to reach the second steel plate 20 and that has a relatively small nugget diameter RN 1, a surface 31a of the molten pool 31 is depressed because of not only the molten metal used to fill the gap G but also generation of spatter, as shown in FIG. 5(a).

### —Second Step—

In the second step, the outer peripheral edge of the molten pool 31 formed in the first step is circularly scanned and irradiated with the first laser beam LB1 that has the relatively small spot diameter D1 and has the relatively high energy density, by the method so-called “LSW” as shown in FIG. 5(b). Thus, the outer peripheral edge of the molten pool 31 is molten and the molten pool 31 is enlarged.

In the second step also, since the irradiation is performed with the first laser beam LB1 having the relatively high energy density, the keyhole melting is performed as shown in FIG. 6(a). Therefore, although the molten pool 31 that has a relatively large nugget diameter RN 2 is formed, the surface 31a of the molten pool 31 is depressed because of not only the molten metal used to fill the gap G but also generation of spatter, as shown in FIG. 5(b).

### —Third Step—

In the third step, the outer peripheral edge of the molten pool 31, which is enlarged in the second step, is circularly scanned and irradiated with the second laser beam LB2 that is set to have the spot diameter D2 larger than the spot diameter D1 of the first laser beam LB1 and that has a relatively low energy density, by the method so-called “LSW” as shown in FIG. 5(c).

In the third step, since the irradiation is performed with the second laser beam LB2 having the relatively low energy density, the heat-transfer melting is performed as shown in FIG. 6(b). More specifically, due to the irradiation with the second laser beam LB2 having the relatively low energy density, only a small amount of the first steel plate 10 sublimates. Thus, as shown in FIG. 6(b), the deep keyhole 10c is not formed in the first steel plate 10, but a wide and shallow keyhole 10d is formed. Due to such a wide and shallow keyhole 10d, the heat absorption area is reduced, which causes slow and gentle melting of the first steel plate 10 as indicated by the arrows in FIG. 6(b). As a result, the amount of molten metal that is scattered (spatter amount) is decreased.

In the molten pool 31 formed as described above so as to have the relatively large nugget diameter RN 2, the surface 31a of the molten pool 31 is hardly depressed and is substantially flat because of not only the molten outer peripheral edge that flows toward the central part of the molten pool 31 but also almost no generation of spatter scattering, as shown in FIG. 5(c) (see the above item (1)).

Furthermore, since the outer peripheral edge of the molten pool 31 is gently molten by the heat-transfer melting, the molten metal is molten and fallen in the oblique direction relative to the rear surface 10b of the first steel plate 10, as indicated by reference sign 33 in FIG. 5(c). In this way, in the welding part 30 made by congelation of the molten pool 31, the inclination angle β is smaller than the inclination angle α as shown in FIG. 1. The inclination angle α is an angle of the welding part 30 at a position within the second steel plate 20 relative to a plane orthogonally intersecting with the layer direction. The inclination angle β is an angle of the welding part 30 at a position corresponding to the gap G between the first steel plate 10 and the second steel plate 20 relative to a plane orthogonally intersecting with the layer direction.

Thus, by relatively decreasing the inclination angle β relative to the plane orthogonally intersecting with the layer direction, it is possible to relatively increase the angle that is made by the rear surface 10b of the first steel plate 10 and the outer peripheral surface of the welding part 30, that is, the angle θ at the back of the throat (see the above item (2)).

In addition, the relatively large throat depth T can be maintained because of not only the surface 31a of the molten pool 31 hardly depressed and substantially flat but also the relatively large angle θ at the back of the throat, regardless of the relatively large gap G and the relatively thin first steel plate 10 (see the above item (3)).

Thus, according to this embodiment, the outer peripheral edge of the molten pool 31 on the first steel plate 10 is irradiated with the second laser beam LB2 that has the relatively large spot diameter D2 and that has the relatively low energy density such that the outer peripheral edge of the molten pool 31 is molten by heat-transfer melting. With such a simple configuration, it is possible to increase the throat depth T so as to improve the joining strength, and also possible to increase the angle θ at the back of the throat so as to reduce generation of cracks due to stress concentration to the element 30b.

### Experimental Examples

Here, a description will be given on experimental examples conducted in order to confirm the effects of the laser welding method of this embodiment.

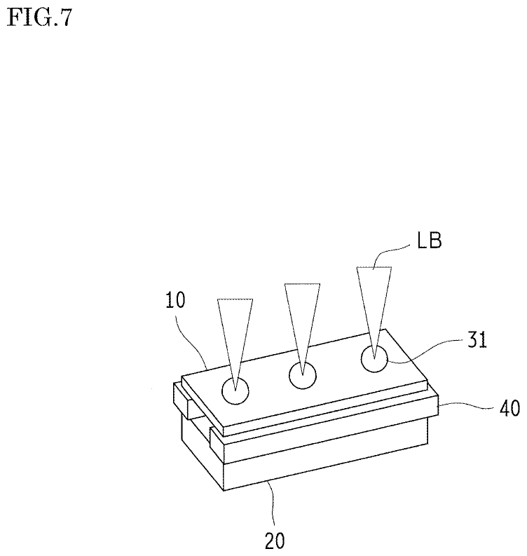

In the experimental examples, a galvanized steel plate having the thickness of 0.7 mm was used as the first steel plate 10 while a galvanized steel plate having the thickness of 1.4 mm was used as the second steel plate 20. The gaps G of the examples were set respectively to 0.1 mm, 0.3 mm and 0.5 mm. Under these conditions, the first steel plate 10 and the second steel plate 20 were layered so that they were welded by the above-described laser welding method using the laser welding apparatus 50 (laser maximum output: 6000 W). More specifically, the welding was circularly performed, and the interval between the adjacent welding spots was 6 mm. Each welding spot was irradiated 400 times, and thus the total number of irradiation was 1200 times. In order to adjust the gap G, a spacer 40 was used between the first steel plate 10 and the second steel plate 20 as shown in FIG. 7.

As a result of the above experiments, it was confirmed, in all the cases in which the respective gaps G were set to 0.1 mm, 0.3 mm and 0.5 mm, that the welded structure 1 was reliably obtained, in which: (1) depression on the surface 30a of the welding part 30 is small and thus the surface 30a is substantially flat; (2) the angle θ at the back of the throat is relatively large; and (3) the relatively large throat depth T is ensured, as shown in FIG. 1.

### —Fatigue Peeling Text and CAE Stress Analysis—

Here, a description will be given on results of tests conducted in order to confirm advantages obtained by relatively increasing the angle θ at the back of the throat. Specifically, the tests conducted here were the fatigue peeling test (in accordance with Japanese Industrial Standards (JIS) Z3138 and the like) and the CAE stress analysis.

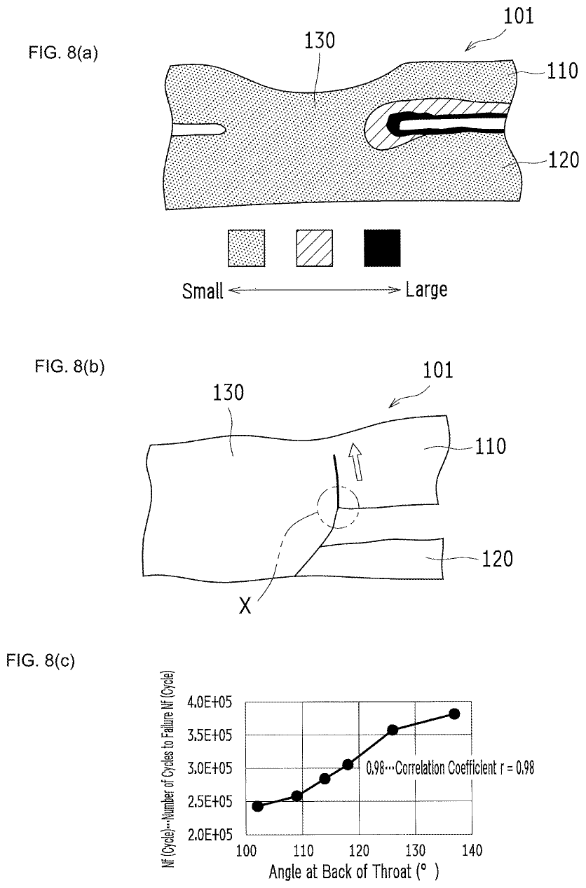

FIG. 8(a) is a CAE (Computer Aided Engineering) stress analysis diagram of the conventional welded structure 101. FIG. 8(b) is a diagram schematically illustrating the conventional welded structure 101 after being submitted to a fatigue test. FIG. 8(c) is a graph indicating a relationship between the angle θ at the back of the throat and the number of cycles to failure Nf. The conventional welded structure 101 having the relatively small angle θ at the back of the throat was subjected to the CAE analysis at the time of the fatigue test. As a result, as shown in FIG. 8(a), it was confirmed that the stress was concentrated at the outer peripheral edge of the welding part 130 on the rear surface 110b of the first steel plate 110. Also, in the conventional welded structure 101 after the fatigue test, as can be seen from a part “X” in FIG. 8(b), the outer peripheral edge of the welding part 130 on the rear surface 110b of the first steel plate 110 served as an origin of the crack so that the crack developed in the direction indicated by the outlined allow in FIG. 8(b).

In contrast, in the welded structure 1 of this embodiment, which has the relatively large angle θ at the back of the throat, no crack was generated after the fatigue test. Furthermore, as shown in FIG. 8(c), the angle θ at the back of the throat and the number of cycles to failure Nf have a positive correlation (correlation coefficient r=0.98). Thus, it was confirmed that the fatigue strength was improved in the welded structure 1 of this embodiment, which has the relatively large angle θ at the back of the throat.

### Other Embodiments

The present invention is not limited to the above embodiment. The present invention may be embodied in other forms without departing from the gist or essential characteristics thereof.

In the steps 1 and 2 of the above embodiment, the scanning with the first laser beam LB1 is circularly performed. However, the present invention is not limited thereto. The scanning with the first laser beam LB1 may be performed so as to draw another pattern, provided that the molten pool 31 is formed.

Also in the above embodiment, the present invention is applied to the welded structure 1 made of the first steel plate 10 and the second steel plate 20 layered on each other. However, the present invention is not limited thereto. The present invention may be applied to a welded structure made of three or more steel plates layered on one another.

Also in the above embodiment, the present invention is applied to the welding of the relatively thin first steel plate 10 having the thickness t1 of 1 mm or less. However, the present invention is not limited thereto. The present invention may be applied to the welding of the first steel plate 10 having the thickness t1 more than 1 mm.

The above embodiment is therefore to be considered in all respects as illustrative and not limiting. All modifications and changes that come within the meaning and range of equivalency of the claims are intended to be embraced therein.

### INDUSTRIAL APPLICABILITY

With the present invention, it is possible to improve the joining strength by increasing the throat depth and to prevent generation of cracks due to stress concentration by increasing the angle at the back of the throat. Thus, the present invention is suitably applied to a laser welding method for lap welding of a plurality of steel plates layered on each other by being irradiated with a laser beam, and also to a welded structure formed by the laser welding method.

### REFERENCE SIGNS LIST

1 Welded structure
10 First steel plate
20 Second steel plate
30 Welding part
31 Molten pool
D1 Spot diameter
D2 Spot diameter
LB1 First laser beam
LB2 Second laser beam

What is claimed is:

1. A laser welding method for lap welding of a plurality of steel plates layered on each other by irradiation with a laser beam, in which the plurality of steel plates is constituted from first to n-th steel plates (n is an integer equal to or greater than 2) in this order from a surface to be irradiated with the laser beam, the method comprising:
a step of forming a molten pool that penetrates between the first steel plate and a (n−1)-th steel plate in a layer direction and that reaches the n-th steel plate by irradiating the first steel plate with a first laser beam; and
a step of melting an outer peripheral edge of the molten pool by irradiating an outer periphery of the molten pool on the first steel plate with a second laser beam having a spot diameter larger than a spot diameter of the first laser beam.

2. The laser welding method according to claim 1, wherein
scanning and irradiation are circularly performed with the first laser beam such that the molten pool is formed.

3. The laser welding method according to claim 1, wherein
a thickness of the first steel plate is smaller than respective thicknesses of the second to n-th steel plates.

4. A welded structure made by lap welding of a plurality of steel plates layered on each other by irradiation with a laser beam, in which the plurality of steel plates is constituted from first to n-th steel plates (n is an integer equal to or greater than 2) in this order from a surface to be irradiated with the laser beam, comprising:
a welding part made from a molten pool after congelation, the welding part penetrating between the first steel plate and a (n−1)-th steel plate in a layer direction and reaching the n-th steel plate, wherein
an inclination angle of the welding part at a position corresponding to a gap between the first steel plate and a second steel plate relative to a plane orthogonally intersecting with the layer direction is smaller than an inclination angle of the welding part at a position within the second steel plate relative to the plane orthogonally intersecting with the layer direction.

5. The welded structure according to claim 4, wherein
a thickness of the first steel plate is smaller than respective thicknesses of the second to n-th steel plates.
